(19) United States
(12) Patent Application Publication
(10) Pub. No.: US 2003/0140715 A1
(43) Pub. Date: Jul. 31, 2003

(54) Fuel sampling method and apparatus

(76) Inventors: David Howard Burke, Flint, MI (US); Michael Joseph Niemiec, Brighton, MI (US); Charles Robert Harrington, Troy, MI (US); David K. Lambert, Sterling Heights, MI (US)

Correspondence Address: VINCENT A. CICHOSZ, DELPHI TECHNOLOGIES, INC., Legal Staff Mail Code: 480-414-420, P.O. Box 5052, Troy, MI, 48007-5052, US

(21) Appl. No.: 10/062,581

(22) Filed: Jan. 31, 2002

(51) Int. Cl. G01N 1/14; F02D 41/00

(52) U.S. Cl. 73/863.84; 123/179.16; 123/1 A

(57) ABSTRACT

A method of reducing engine cold start up emissions and an apparatus for isolating a fuel sample for testing purposes. According to the methodology the driveability index of the fuel is sensed utilizing an onboard sensor and the sensed fuel driveability index is inputted to the engine controller for utilization by the engine controller in determining the fueling algorithm for minimizing emissions during the next cold start up of the engine. The sensor determines the driveability index by evaluating a fuel sample collected onboard during the previous running cycle of the engine. The fuel sample is pumped from the vehicle fuel tank to an onboard collection point by the vehicle fuel pump during the previous running cycle of the engine. The fuel sampling apparatus includes a sample cup, a cylinder having a bore and an inlet port for connection to the fuel pump and a piston rod defining an axial passage having an inlet port and a discharge port. The piston rod is mounted in the bore for movement between an operative position in which the passage inlet port communicates with the cylinder inlet port and the passage discharge port is positioned in overlying relation to the sample cup and a retracted position in which the passage inlet port is blocked from communication with the cylinder inlet port and the discharge port is withdrawn from the sample cup whereby to isolate a fuel sample in the sample cup.

### TECHNICAL FIELD OF THE INVENTION

This invention relates a method and apparatus for determining the driveability index of a fuel for use in engine control.

### BACKGROUND OF THE INVENTION

It is known in the art relating to automotive engines that a key gasoline characteristic for good driveability is volatility. Volatility is especially important at the time an engine is started because liquid gasoline must evaporate and mix with air to form a combustible mixture. If too little gasoline is added, the engine will not start; if gasoline beyond that needed to initiate combustion is added, extra hydrocarbons from an unburned portion of gasoline are found in the exhaust. Moreover, because gasoline sold in the United States varies in volatility, there is a trade off in engine design between low hydro-carbon emissions and good driveability with low volatility fuel.

To describe the effect of gasoline volatility on the cold start and warm up driveability of a vehicle, a driveability index (DI) has been developed. DI is a number that helps predict how different volatility gasolines affect engine performance and is correlated to how often an engine might stall, stumble, surge or hesitate. For gasoline that does not contain oxygenates such as ethanol or methyl tertiary-butyl ether (MTBE), the definition of DI is based on a laboratory test (American Society for Testing and Materials D 86) in which a sample of gasoline is distilled as its temperature is raised. The fraction distilled is measured as a function of temperature and DI=1.5T₁₀+3T₅₀+T₉₀ where Tₓ is the temperature in degrees Fahrenheit at which x % of the gasoline sample has been distilled. Most drivers are satisfied with the engine performance when the engine fuel has a DI value of 1200 or lower.

Because DI was developed by using carbureted vehicles and non-oxygenated fuels, a modified equation was needed to account for the changes in engine and fuel. With oxygenated gasoline an expression that provides better correlation to engine performance is: DI=1.5T₁₀+3T₅₀+T₉₀+86_{.EtOH} which includes the effect if 10% (in volume) of ethanol in fuel. The variable _{.EtOH} is 1 if 10% ethanol is present, and zero otherwise. The effects of another popular oxygenated compound additive in fuel, MTBE (methyl tertiary butyl ether) are often not included in the DI calculation since MTBE is to be eliminated from fuels by the end of the year 2003.

With the knowledge of the fuel driveability index value, proper amounts of fuel can be dispensed to the engine which can help a smooth engine start and produce less emissions from the engine.

It is particularly desirable to estimate DI onboard a vehicle. To provide customer satisfaction, engines are calibrated to reliably start with fuel of the lowest expected DI. This is done by increasing the amount of fuel in the air fuel mixture. Consequently, for most starts, the engine's air fuel ratio is richer than optimum. Some of this extra gasoline passes unburned into the exhaust. This is particularly detrimental at the time of a cold start because the catalytic converter is too cold to be active. The added hydro-carbon concentration is typically emitted to the environment. Estimating DI onboard would prevent the air fuel ratio to be more precisely controlled. The engine would be calibrated to reliably start while extra fuel would only be added when needed to compensate for fuel volatility. On average, less fuel would be used for cold starts resulting in a decrease in fleet-average exhaust hydro-carbon emissions. This decrease in air pollution is an important environmental benefit.

### SUMMARY OF THE INVENTION

This invention relates to a method of controlling emissions of a motor vehicle internal combustion engine fueled by a fuel stored in an onboard fuel container for delivery to an engine controller.

The method comprises sensing the driveability index of the fuel utilizing an onboard sensor and inputting the sensor driveability index to the engine controller for utilization by the engine controller in determining the fueling algorithm for minimizing emissions during the next cold start up of the engine. This methodology provides an onboard system for minimizing emissions during cold start up.

According to a further aspect of the invention methodology, the sensor determines the driveability index by evaluating a fuel sample collected onboard during the previous running cycle of the engine. This methodology provides a convenient and effective means of providing an accurate driveability index.

According to a further aspect of the invention methodology, the motor vehicle includes a fuel pump and the fuel sample is pumped from the fuel container to an onboard collection point by the fuel pump during the previous running cycle of the engine. This methodology provides a convenient means of providing the required fuel sample utilizing existing motor vehicle equipment.

According to a further aspect of the invention methodology, the sample is collected in a sample cup and the sample cup and the fuel pump are positioned in the fuel container. This methodology provides a convenient packaging for the equipment required to determine the driveability index.

According to a further aspect of the invention methodology, the fuel pump is positioned in a reservoir bucket positioned in the fuel container and the sample cup is positioned in a vapor dome of the fuel container. This methodology provides further advantages in packaging the equipment required to determine the driveability index.

The invention further provides a fuel sampling apparatus for isolating a fuel sample for testing purposes.

The fuel sampling apparatus of the invention comprises a sample cup, a cylinder having a bore and an inlet port for connection to the fuel pump, and a piston rod defining an axial passage having an inlet port and a discharge port. The piston rod is mounted in the bore for movement between an operative position in which the passage inlet port communicates with the cylinder inlet port and the passage discharge port is positioned in overlying relation to the sample cup to allow the delivery of pressurized fuel from the fuel pump to the cylinder inlet port to the passage inlet port and through the passage outlet port to the sample cup, and a retracted position in which the passage inlet port is blocked from communication with the cylinder inlet port and the discharge port is withdrawn from the sample cup. This apparatus provides a simple and effective mechanism for isolating a fuel sample in the sample cup for testing purposes.

According to a further feature of the fuel sampling apparatus, the apparatus further includes an annular valving member carried by the piston rod and slidably mounted in the cylinder bore. The valving member is movable relative to the piston rod between an open position in which the passage inlet port communicates with the cylinder bore and a closed position in which the passage inlet port is blocked from communication with the cylinder bore. This valving arrangement provides a convenient means of delivering a fuel sample to the fuel cup and thereafter isolating the fuel sample.

According to a further feature of the fuel sampling apparatus, the apparatus further includes stop structure coacting with the piston rod to stop the piston rod in its operative position. The valving member moves with the piston in its closed position relative to the piston rod until the piston rod encounters the stop structure whereafter the valving member moves relative to the piston rod to its open position to allow fuel flow from the cylinder bore through the piston passage and into the sample cup. This arrangement ensures the accurate, positive delivery of the fuel to the sample cup.

According to a further feature of the fuel sampling apparatus, the apparatus further includes a biasing means resiliently resisting movement of the piston rod to its extended position and operative to return the piston rod to its retracted position upon shut-off of the vehicle fuel pump. This arrangement provides a convenient means of returning the apparatus to its neutral or start position.

According to a further feature of the fuel sampling apparatus, the apparatus further includes means operative in response to arrival of the piston rod at its retracted position to move the valving member to its closed position. This arrangement provides a convenient means of restoring the apparatus to its neutral or start position.

According to a further feature of the fuel sampling apparatus, the biasing means acts on the valving member; the apparatus further includes piston rod stop structure defined by coacting stop structure on the cylinder and the piston rod and valving member stop structure defined on the inboard end of the piston rod; the piston rod stop structure defines the retracted position of the piston rod; and the biasing means continues to act on the valving member following arrival of the piston rod at its retracted position and moves the valving member to its closed position as defined by the valving member stop structure. This arrangement provides a ready and effective means for moving the valving member to its closed position to define the neutral or start position of the apparatus.

The invention further provides a fuel module for positioning in a fuel container of a motor vehicle. The module comprises a reservoir bucket; a fuel pump positioned in the bucket for connection to an engine of the vehicle; a sample cup; and sample isolating device receiving fuel from the fuel pump and operative to position a sample of the fuel in the sample cup. This module may be positioned in the fuel container of the vehicle where it functions to provide the primary fuel delivery apparatus of the vehicle and further provide a means of sampling a characteristic of the fuel for use in determining low emission engine control parameters.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a fragmentary schematic view of a motor vehicle embodying the invention methodology and apparatus;

FIG. 2 is a view of a fuel module according to the invention;

FIG. 3 is a view of a sensor assembly forming a part of the fuel module with a sensor pump of the sensor assembly shown in a retracted position;

FIG. 4 is a plan view corresponding to FIG. 3;

FIG. 5 is a cross sectional view of the sensor assembly with the sensor pump shown in an extended or operative position; and

FIG. 6 is a plan view corresponding to FIG. 5.

### DESCRIPTION OF THE PREFERRED EMBODIMENT

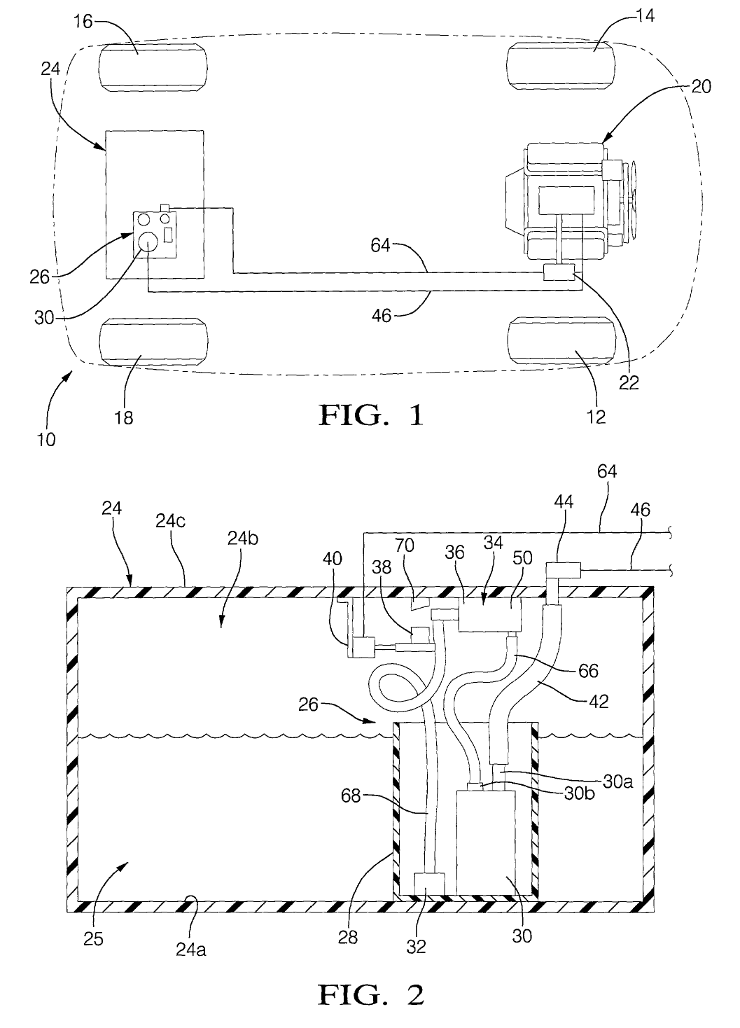

The motor vehicle 10 seen schematically and fragmentary in FIG. 1 includes wheel assemblies 12, 14, 16 and 18, an internal combustion engine 20, an engine control unit (ECU) 22, a fuel container or tank 24 for containing a fuel 25 such as gasoline, and a fuel module 26.

ECU 22 may comprise any device operating to determine and control the air/fuel ratio delivered to the engine 20. It may take the form of a carburetor, or more typically with respect to modern day vehicles, may comprise an electronic unit receiving a plurality of sensor inputs and delivering a plurality of sensor controlled outputs including an air/fuel ratio output. The sensor inputs may include exhaust oxygen concentration, engine coolant temperature, throttle position, atmospheric pressure, manifold vacuum, engine crank shaft position, battery voltage, vehicle speed, transmission gear indication, park/neutral mode, brake pedal engagement, A/C clutch engagement, and cold start program modifier conditions. The sensor outputs may include control of air/fuel ratio, spark timing, EGR valve, and idle speed. For purposes of the present invention, we are concerned primarily with the ECU system output relating to air/fuel ratio and the sensor inputs that relate to the determination by the ECU of the air/fuel ratio.

Fuel module 26 (FIGS. 1 and 2) includes a reservoir bucket 28, an electric fuel pump 30, a venturi pump 32, and a sensor assembly 34.

Sensor assembly 34 includes a sensor pump 36, a sample cup 38, and a sensor 40.

Reservoir bucket 28 is sized to fit within the fuel tank 24, supported on the tank lower wall 24a.

Electric fuel pump 30 is sized to be fitted in reservoir bucket 28 and has a primary output 30a communicating with a hose 42 which in turn communicates with a fitting 44 which in turn communicates with a fuel line 46 extending in known manner to engine 20 whereby operation of fuel pump 30 draws fuel 25 from tank 24 for delivery by fuel line 46 to the engine.

Venturi pump 42 is positioned within reservoir bucket 28 and operates in known manner to draw fuel from tank 24 into the reservoir bucket 28 where it may be inputted to pump 30 for delivery to the engine.

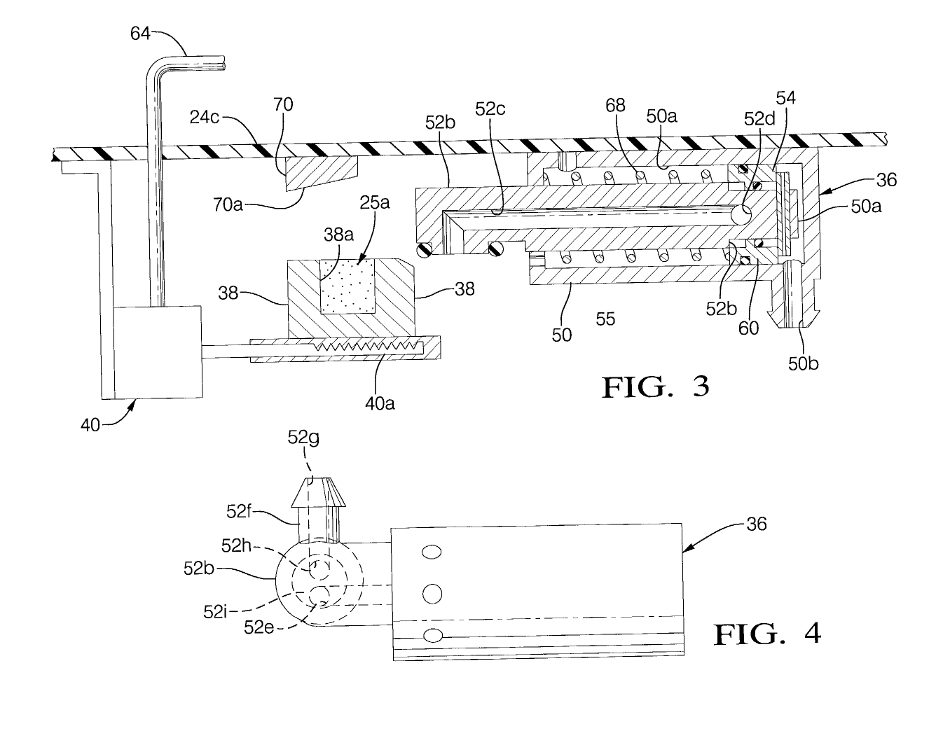

Sensor pump 36 (FIGS. 3-6) includes a cylinder or barrel 50 defining a bore 50a, a piston rod 52 having an inboard end 52a positioned in bore 50a and an outboard end 52b positioned outside of the cylinder, a piston valving member 54 slidably and sealingly mounted in bore 50a and slidably positioned on the inboard end 50a of piston rod 50, and a return spring 55.

Piston rod 52 defines a central axial passage 52c extending from an inlet port 52d proximate the inboard end of the piston rod to a discharge port 52e proximate the outboard end of the piston rod. Inlet port 52d extends radially for communication with cylinder bore 50a and discharge port 52e extends radially downwardly for communication with sample cup 38. Piston rod 52 further includes a spigot portion 52f extending radially outwardly from outboard end 52b and defining 12an outlet passage 52g connecting to an outlet port 52h overlying cup 38 proximate discharge port 52e.

Piston valving member 54 includes a main body portion 54a slidably mounted in bore 50a and an internal rib portion 54b slidably guiding on a reduced diameter portion 52i of piston rod 52 proximate the inboard end 52a of the piston rod. A radial stop pin 56 carried by the inboard end 52a of the piston rod coacts with the main body portion 54a of valving member 54 to limit and define the sliding movement of valving member 54 on the piston rod.

O-rings 58 and 60 respectively seal the valving member 54 with respect to the cylinder bore 50a and the valving member 54 with respect to the reduced diameter portion 52i of the piston rod. A further O-ring 62 is positioned on a hub portion 52j of the piston rod proximate outlet port 52e; an input port 50b communicates with cylinder bore 50a; and bore 50a is vented by vent ports 50c.

Discharge port 52e and outlet port 52h will be seen to be circumscribed by hub portion 52j.

Sample cup 38 is positioned in underlying relation to discharge port 52e and outlet port 52j whereby to receive fuel delivered through passage 52c, and defines a cup shaped volume 38a precisely defined to receive a precise measure of fuel constituting a fuel sample 25a.

Sensor 40 is associated with sample cup 38 and is operative to test the fuel sample 25a isolated in sample cup 38 and determine the driveability index (DI) of the fuel, which index may be inputted to the ECU by a lead 64 for utilization by the ECU as a sensor input to determine the air/fuel ratio for delivery to the engine. In this regard it will be understood that the ECU embodies a fueling algorithm based on a plurality of sensor inputs including the driveability index inputted by a lead 64.

Sensor 40 may take various forms and, for example, may operate on the basis of evaporative calorimetry or capacitance measurement. In both cases, a sample of liquid fuel is heated by a resistance 40a underlying the sample cup 38 and the evaporation of the fuel is monitored and measured. With respect to evaporative calorimetry, the intent is to monitor the evaporation of the fuel sample by measuring the heat absorbed by the sample as it evaporates. With respect to capacitance measurement, the intent is to monitor the evaporation of the fuel sample by measuring an electrical capacitance that varies as a function of the remaining volume of liquid fuel. Details of an evaporative calorimetry sensor suitable for use in the present invention are disclosed in co-pending U. S. patent application Ser. No. ______ assigned to the assignee of the present application. Details of a capacitance measurement sensor suitable for use in the present invention are disclosed in U.S. patent application Ser. No. 09/932,333 assigned to the assignee of the present invention. Irrespective of the methodology used to determine driveability index, the sensor functions to output a electronic measure of the driveability index of the fuel sample via lead 64 for use by ECU 22 in determining the appropriate fueling algorithm.

Note that the reservoir bucket 28 is positioned within the fuel tank 24 (for example supported on the floor 24a of the fuel tank) and the sensor assembly 34 is positioned in a vapor dome 24b defined in the upper regions of the fuel tank. A hose 66 extends between a further fuel pump outlet 30b and the inlet 50b of the sensor pump and a further hose 68 extends between the outlet passage 52g of the piston rod 52 and venturi pump 32.

Sensor pump 36 is normally maintained in the neutral or retracted position seen in FIG. 3 by the combined action of return spring 55 positioned in bore 50a and acting on valving member 54, and a stop structure 52g defined on piston rod 52 proximate the outboard end 52b of the piston rod. Specifically, spring 55 urges valve member 54 against stop pin 56 and urges piston rod 52 to the right as viewed in FIG. 3 until stop 52g encounters a coacting surface on cylinder 50 to define the retracted position of the piston rod. It will be seen that in this position the ports 52e and 52h defined at the outboard end of the piston rod are withdrawn from overlying relation to the sample cup 38.

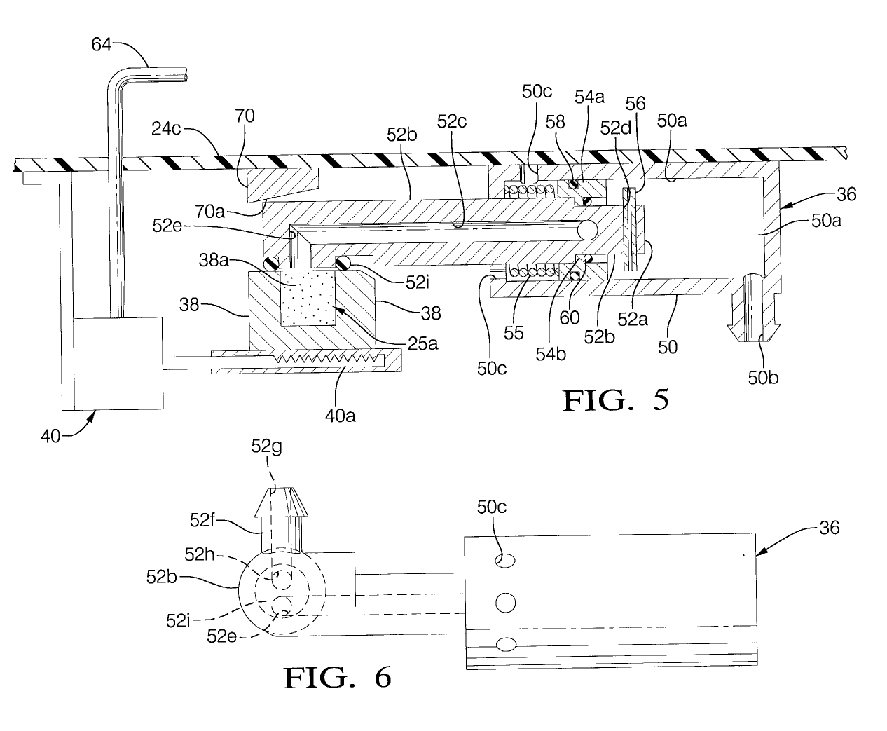

When the engine 20 is started up, fuel 25 under pressured is delivered by tube 66 and port 50b to bore 50a where the pressurized fuel acts against piston rod 50 and valving member 54 causing both to slide to left within the bore 50a. Valving member 54 and piston rod 50 continue to slide together to the left, compressing spring 55, until O-ring 62 covers sample cup 38. As the O-ring 62 moves into position in overlying relation to sample cup 38, the outboard end 52b of the piston rod encounters a positive stop 70 which halts the piston rod in precise overlying relation to the sample cup. The operative face 70a of stop 70 is sloped so as to compress the O-ring 62 as it slides into place and provide a positive seal as between the piston rod and the sample cup. As the piston rod is halted by the stop 70, valving member 54 continues to slide within bore 50a under the urging of the pressurized fuel until rib 54b encounters a shoulder 52k at the juncture of the reduced diameter portion 52a of the piston rod and the main body of the piston rod to halt the relative movement of the valving member on the piston rod. During this final movement of the valving member relative to the piston rod, the valving member moves from a closed position seen in FIG. 3 in which communication between bore 50a and inlet port 52d is blocked to an open position seen in FIG. 5 wherein communication is established between bore 50a and port 52d. It will be seen that the action of the valving member 54 in its closed position to block communication between bore 50a and the inlet port 52d is augmented by the sealing action of O-ring 60. It will further be seen that the movement of the outboard end of the piston rod into overlying sealed relationship with respect to sample cup 38 coincides with the movement of the valving member from a closed to an open position so that, as the piston rod moves into overlying relation to the fuel cup, pressurized fuel begins to flow through the passage 52c and discharge port 52e into the sample cup and thereafter via outlet port 52h, passage 52g, and hose 68 to venturi pump 32. The continuous flow of fuel through the cup 38a has the effect of continuously flushing the cup of any contaminants and maintaining the cup in a full condition.

When the engine is thereafter shut-off, fuel pump 30 shuts off allowing pressure to drop to essentially atmospheric on the fuel side of the valving member 54 and allowing spring 55 to push the valving member and piston rod from the operative position of FIG. 5 to the retracted position of FIG. 3. As the piston rod moves to its retracted position under the urging of spring 55 it is stopped by the engagement of stop structure 52g and the coacting surface of the cylinder but the valving member 54 continues to move relative to the piston rod under the urging of spring 55 until it encounters stop pin 56. This final movement of the valving member relative to the piston rod has the effect of moving the valving member from its open position, allowing communication between bore 50a and inlet port 52d, to its closed position, blocking communication between bore 50a and inlet port 52d whereby to terminate the flow of fuel to the sample cup. During the retracting movement of the outboard end 52b of the piston rod, O-ring 62 drags across the upper face of the sample cup with a wiping action to provide a level, precision fill of the sample cup and an accurate fuel sample volume 25a. Withdrawal of the outboard end of the piston rod from overlying relation to the sample cup exposes the upper face of the fuel sample 25a so that fuel vapors from the sample do not have an opportunity to recondense and run back into the cup. It will be understood that such recondensing would adversely affect the accuracy of the DI determination by the sensor 40.

Once the piston rod has moved to its retracted position exposing the fuel sample in the sample cup, sensor 40 is suitably actuated to provide a measure of the driveability index of the fuel sample in the sample cup whereby to generate an electronic driveability index signal on lead 64 for inputting to ECU 22 where it is stored in memory for use by the ECU in determining the fueling algorithm for minimizing emissions during the next cold start up of the engine. During the next cold start up of the engine, the driveability index input is combined with other sensor inputs to determine the fueling algorithm that would minimize emissions during the next cold start up of the engine. Use of the driveability index derived from a sample obtained during the previous run cycle of the engine facilitates the reduction of exhaust hydro-carbon emissions by enabling more accurate control of the air/fuel ratio at engine start up. This is important in emission control since typically about 80% of the exhaust hydro-carbon emissions occur during the initial phase of engine start up before the catalytic convertor has warmed up enough to light off and before the exhaust oxygen sensor has warmed up enough to begin closed loop control of the air/fuel ratio.

Although the stop 70, cylinder 50, and sensor 40 have been schematically shown to be suitably secured to the upper wall 24c of the fuel tank, it will be understood that this arrangement is for illustrative purposes only and that, in practicality, the various elements of the sensor assembly might be carried by the reservoir bucket 28 to form a fuel module comprising the reservoir bucket 28, venturi pump 32, sensor 40, sample cup 38, and pump 36, which fuel module could be suitably installed in the tank 24 by lowering the fuel module through an opening in the top wall 24c of the tank and including a cover member as a part of the fuel module that is moved into place as the module comes to rest on the floor of the fuel tank to seal the tank opening.

It is contemplated that the DI measurement would be performed at the end of each trip of the vehicle and, at the next cold start of the engine, the previously measured DI value would be retrieved from the ECU memory and utilized to determine the air/fuel ratio of the engine in a sense to minimize emissions during engine start up. It is contemplated that the vehicle controls would be configured such that the driveability index calculated in accordance with the invention would not be utilized in each subsequent start up of the engine following an engine shut down but, rather, controls would be included such that the previously derived driveability index would only be utilized subsequently in a cold start up of the engine as determined by the control circuitry. Note in this regard that a typical sensor input to the ECU is engine coolant temperature and this input could be utilized to determine those start ups which would qualify as cold start ups utilizing the driveability index determined at the previous shut down of the engine. Thus engine start ups occurring shortly after engine shut offs (such for example in scenarios where the vehicle is stopped for refueling) would not qualify for utilization of the driveability index since there is no need in this scenario to be concerned with excessive emissions during start up.

The invention will be seen to provide an improved methodology and apparatus for reducing exhaust gas emissions during cold engine start up and will further be seen to provide a fuel sample isolating device that provides a fuel sample for testing purposes in a convenient and efficient manner.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A method of controlling emissions of a motor vehicle internal combustion engine fueled by a fuel stored in an onboard fuel container for delivery to an engine controller, the method comprising:
sensing the driveability index of the fuel utilizing an onboard sensor; and
inputting the sensed fuel driveability index to the engine controller for utilization by the engine controller in determining the fueling algorithm for minimizing emissions during the next cold start up of the engine.

2. A method according to claim 1 wherein:
the sensor determines the driveability index by evaluating a fuel sample collected onboard during the previous running cycle of the engine.

3. A method according to claim 2 wherein:
the motor vehicle includes a fuel pump; and
the fuel sample is pumped from the fuel container to an onboard collection point by the fuel pump during the previous running cycle of the engine.

4. A method according to claim 3 wherein:
the sample is collected in a sample cup; and
the sample cup and the fuel pump are positioned in the fuel container.

5. A method according to claim 4 wherein:
the fuel pump is positioned in a reservoir bucket positioned in the fuel container; and
the sample cup is positioned in a vapor dome of the fuel container.

6. A method according to 5 wherein the method includes the further steps of:
providing a cylinder having a bore;
providing a piston rod defining an axial passage having an inlet port and a discharge port;
positioning the piston rod in the bore with the inlet port positioned in the bore and the discharge port positioned outside of the cylinder;
mounting the piston rod for movement in the bore between an operative position in which the passage discharge port is positioned in overlying relation to the sample cup and a retracted position in which the discharge port is withdrawn from the sample cup; and
with the engine running during the previous running cycle, delivering pressurized fuel from the fuel container to the cylinder in a manner to move the piston rod from its retracted to its operative position and delivering pressurized fuel to the inlet port of the passage in response to arrival of the piston rod at its operative position, whereby to deliver fuel to the sample cup through the passage and discharge port.

7. A method according to claim 6 wherein the method includes the further step of moving the piston rod from its operative to its retracted position in response to shutting off of the engine, whereby to withdraw the discharge port from the cup and expose the cup for fuel testing.

8. A method according to claim 7 wherein the movement of the piston rod from its operative to its retracted position is accomplished by biasing means yieldably resisting the movement of the piston rod from its retracted position to its operative position.

9. A method according to claim 7 wherein:
the piston rod further includes an outlet port proximate the discharge port communicating with a reservoir and positioned in overlying relation to the cup with the discharge port positioned in overlying relation to the cup; and
the method includes the further step of passing the fuel from the discharge port, into the cup, and out of the cup through the outlet port to the reservoir, whereby to flush the cup and fill the cup for sampling purposes.

10. A method according to claim 9 wherein the reservoir is defined by the reservoir bucket.

11. A method of controlling emissions in a motor vehicle drive system of the type including an internal combustion engine and a fuel container for containing a fuel for delivery to the engine, the method comprising:
providing an onboard sensor operative to determine a driveability index of the fuel;
utilizing the sensor to sense the driveability index of the fuel upon shut-down of the engine; and
utilizing the sensor driveability index to determine the engine fueling algorithm for the next cold start-up of the engine.

12. A method according to claim 11 wherein:
the drive system includes an engine controller; and
the sensed driveability index is inputted to the engine controller for utilization by the engine controller during the next cold start of the engine.

13. A method according to claim 12 wherein the sensor determines the driveability index of a sample of fuel collected onboard during the operation of the engine preceding shut-down.

14. A method according to claim 13 wherein:
the drive system includes a fuel pump for pumping fuel from the fuel container to the engine; and
the sample is pumped by the fuel pump to an onboard sample collection point during operation of the engine proceeding shut-down.

15. A method according to claim 14 wherein:
the sample is tested at the collection point following shut-down to determine the driveability index.

16. A method according to claim 15 wherein a sample cup is positioned at the collection point.

17. A method according to claim 16 wherein the fuel pump and the sample cup are positioned in the fuel container.

18. A method according to claim 17 wherein:
the fuel pump is positioned in a reservoir bucket positioned in the fuel container; and
the sample cup is positioned in a vapor dome of the fuel container.

19. An onboard method of isolating a fuel sample for testing purposes in a motor vehicle having an engine and a fuel container for containing a quantity of the fuel to be isolated and tested, the method comprising:
providing an onboard sample cup for containing a fuel sample;
providing an onboard cylinder having a bore;
providing an onboard piston rod defining an axial passage having an inlet port and a discharge port;
positioning the piston rod in the bore with the inlet port positioned in the bore and the discharge port position outside of the cylinder;
mounting the piston rod in the bore for movement between an operative position in which the passage discharge port is positioned in overlying relation to the sample cup and a retracted position in which the discharge port is withdrawn from the cup; and
with the engine running, delivering pressurized fuel from the fuel container to the cylinder in a manner to move the piston rod from its retracted to its operative position and delivering pressurized fuel to the inlet port of the passage in response to arrival of the piston rod at its operative position, whereby to deliver fuel to the sample cup through the passage and discharge port.

20. A method according to claim 19 wherein the method includes the further step of moving the piston rod from its operative to its retracted position in response to shutting off of the engine, whereby to withdraw the discharge port from the cup and expose the cup for fuel testing purposes.

21. A method according to claim 20 wherein:
the piston further includes an outlet port proximate the discharge port communicating with a reservoir and positioned in overlying relation to the cup with the discharge port positioned in overlying relation to the cup; and
the method includes the further step of passing fuel from the discharge port, into the cup, and out of the cup through the outlet port to the reservoir, whereby to flush the cup and fill the cup for sampling purposes.

22. For use with a motor vehicle including an internal combustion engine, an engine controller, a fuel container, and a fuel pump for delivering fuel from the container to the engine controller, a fuel sampling apparatus for isolating a fuel sample for testing purposes, the fuel sampling apparatus comprising:
a sample cup;
a cylinder having a bore and an inlet port for connection to the fuel pump; and
a piston rod defining an axial passage having an inlet port and a discharge port, the piston rod mounted in the bore for movement between an operative position in which the passage inlet port communicates with the cylinder inlet port and the passage discharge port is positioned in overlying relation to the sample cup to allow the delivery of pressurized fuel from the fuel pump to the cylinder inlet port to the passage inlet port and through the passage discharge port to the sample cup, and a retracted position in which the passage inlet port is blocked from communication with the cylinder inlet port and the discharge port is withdrawn from the sample cup whereby to isolate a fuel sample in the sample cup.

23. A fuel sampling apparatus according to claim 22 wherein the apparatus further includes an annular valving member carried by the piston rod and slidably mounted in the cylinder bore, the valving member movable relative to the piston rod between an open position in which the passage inlet port communicates with the cylinder bore and a closed position in which the passage inlet port is blocked from communication with the cylinder bore.

24. A fuel sampling apparatus according to claim 23 wherein the apparatus further includes stop structure coacting with the piston rod to stop the piston rod in its operative position, the valving member moving with the piston in its closed position relative to the piston rod until the piston rod encounters the stop structure, whereafter the valving member moves relative to the piston rod to its open position to allow fuel flow from the cylinder bore through the piston passage and into the sample cup.

25. A fuel module for positioning in a fuel container of a motor vehicle, the module comprising:
a reservoir bucket;
a fuel pump positioned in the bucket for connection to an engine of the vehicle;;
a sample cup; and
a sample isolating device receiving fuel from the fuel pump and operative to position a sample of the fuel in the sample cup.

26. A fuel module according to claim 25 wherein:
the sample isolating device comprises a sample pump including a cylinder defining a bore for receipt of pressurized fuel from the fuel pump and a piston assembly mounted in the cylinder bore, the piston assembly including a piston rod having an axial passage extending from a passage inlet proximate an inboard end of the piston rod positioned in the cylinder bore to a passage discharge positioned outside the cylinder proximate an outboard end of the piston rod; and
the piston rod is movable in the bore between an extended, operative position in which the passage discharge is positioned in overlying relation to the sample cup, whereby to deliver fuel to the cup, and a retracted position in which the passage discharge is withdrawn from the cup.

27. A fuel module according to claim 26 wherein:
the piston assembly further includes a valving member slidably mounted on the inboard end of the piston rod in sealing engagement with the cylinder bore and movable slidably relative to the piston rod between an open position providing communication between the cylinder bore and the passage inlet and a closed position blocking communication between the cylinder bore and the passage inlet.

28. A fuel module according to claim 27 wherein the sample pump further includes biasing means resiliently resisting movement of the piston rod to its extended position and operative to return the piston rod to its retracted position upon shut off of the fuel pump.

29. A fuel module according to claim 28 wherein the sample pump further includes means operative in response to arrival of the piston rod at its retracted position to move the valving member to its closed position.

30. A fuel module according to claim 29 wherein:
the biasing means acts on the valving member;
the sample pump further includes piston rod stop structure defined by coacting stop structure on the cylinder and the piston rod and valving member stop structure defined on the inboard end of the piston rod;
the piston rod stop structure defines the retracted position of the piston rod; and
the biasing means continues to act on the valving member following arrival of the piston rod at its retracted position and moves the valving member to its closed position as defined by the valving member stop structure.
